(19) United States
(12) Patent Application Publication
(10) Pub. No.: US 2022/0397307 A1
(43) Pub. Date: Dec. 15, 2022

(54) MECHANICALLY POWERED SOLAR TRACKING SYSTEM

(71) Applicant: Solar Pivot Power, Wabasha, MN (US)

(72) Inventors: Dale Hanks, Wabasha, MN (US); Uttam Singh, Austin, TX (US); Dan Moravec, Wabasha, MN (US)

(21) Appl. No.: 17/841,345

(22) Filed: Jun. 15, 2022

Related U.S. Application Data
(60) Provisional application No. 63/210,745, filed on Jun. 15, 2021.

(51) Int. Cl. F24S 30/452

(52) U.S. Cl. CPC F24S 30/452; F24S 2030/11

(57) ABSTRACT

A mechanically powered solar tracking system is disclosed. The mechanically powered solar tracking system may include a carriage, a carriage mount connected to the carriage, a pivot shaft including a pivot gear connected to the carriage or, a complex gearbox, a base including legs, a tracker disposed on the base, the tracker including a mechanical energy storage system and a movement modulating system. The mechanical energy storage system may be configured to store mechanical energy as the carriage is rotated from a first position to a second position, and the movement modulation system may be configured to modulate a rotation of the carriage from the second position to the first position as the mechanical energy storage system exerts a rotational force on the carriage.

### PRIORITY CLAIM

The present application claims the benefit of priority of U.S. Provisional Patent Application Ser. No. 63/210,745, titled “Adaptive Solar Tracking System and Portable Mechanical Solar Tracker,” filed Jun. 15, 2021, which is incorporated herein by reference.

### BACKGROUND

Solar tracking by solar panel carriages is often performed using sensors and electronic components. Methods and apparatuses for a mechanical solar tracking carriage, mount, and stand for a solar panel are described herein.

### SUMMARY

One embodiment provides a mechanically powered solar tracking panel mount comprising a carriage, a carriage mount connected to the carriage, a pivot shaft and gearbox connected to the carriage, a base including legs, a tracker disposed on the base, the tracker including a mechanical energy storage system, and a movement modulating system. The disclosed mechanically powered solar tracking panel mount may be equipped with a constant torque spring to store mechanical energy. This energy may be provided by a user at the start of solar tracking operation, using, for example, a hand crank. This stored energy is utilized to rotate a solar panel mount. The release of the stored energy may be modulated using a gear box and a rotary damper approximating the movement of the Sun in relation to the Solar Panel.

Another embodiment provides a mechanically powered solar tracking system comprising a tracker including a mechanical energy storage system and a movement modulating system. The mechanical energy storage system and the movement modulating system are configured to mechanically engage a pivot shaft via a gearbox. The mechanical energy storage system is further configured to store mechanical energy as the pivot shaft is rotated from a first position to a second position, and the movement modulation system is configured to modulate the rotation of the pivot shaft from the second position to the first position as the mechanical energy storage system exerts a rotational force on the pivot shaft.

Other aspects of the disclosure will become apparent by consideration of the detailed description and accompanying drawings.

### BRIEF DESCRIPTION OF THE DRAWINGS

FIG. 1 shows a system level view of a mechanically powered solar tracking system.

FIG. 2 shows several top views of the mechanically powered solar tracking system at different moments of operation during a given day.

FIGS. 3a-c show a rotary constant torque spring motor, a rotary constant counter-torque damper and the spring motor and rotary damper mechanically engaging the pivot shaft within a tracker of a mechanically powered solar tracking system.

FIGS. 4a-d show several views of a spring and hydraulics arrangement configured as a mechanical energy storage system.

FIG. 5 shows a view of a mounting system configured to enable a user to set a desired altitude tilt for a solar panel mounted thereon.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical or hydraulic connections or couplings, whether direct or indirect.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

The Sun's coordinates may be referred to herein as azimuth and altitude. Azimuth refers to the sun's position as measured on the horizontal plane clockwise from the north pole. Altitude refers to the sun's position as measured on the vertical plane with respect to the horizon. The orientation/placement/facing of a carriage configured to carry a solar panel may be referred to in terms of its azimuth and altitude movement/rotation.

Usable energy harvested from solar radiation by a solar panel is often maximized when the solar radiation's angle of incidence is 0°. Studies have shown that a static solar panel may produce up to 40% less energy as compared to a solar panel that is frequently repositioned to ensure the Sun's direct light strikes the surface of the solar panel at right angle. Techniques for positioning a solar panel (also referred as solar tracking) to increase solar energy may be manual, passive or active.

Generally speaking, Earth rotates on its tilted axis (approx. 23.5°) once every 24 hours (approx.). It also revolves around the sun every 365 days (approx.). Because of Earth's tilted axis and its orbit around the sun, solar coordinates as measured on Earth's surface vary based on the latitude, time of the day and day of the Year. In addition, the local time at a location is dependent on its Longitude (e.g., 4 minutes per longitude, broken into hour time zones). Active solar trackers deployed by large scale utilities or, sometimes in commercial and residential settings, may take advantage of location aware services like GPS to facilitate tracking of the sun throughout the year. Other static installations make compromised choices of fixed orientation best suited for the specific latitude and/or time of the year (in the northern hemisphere, south facing and a vertical angle tilt).

The sun's azimuth, when tracked against time, may give a sense of how the sun appears in the sky relative to a location on the Earth. The sun's Azimuth (Δ) can also be tracked relative to time. A reasonable compromise for a single axis (Azimuth) tracker might be to set the altitude such that the Angle of Incidence at Solar Noon is 0°, thus enabling maximum solar power generation for a single axis tracker. An angle of incidence at solar noon=0° for a single axis azimuth tracker might be calculated using the latitude of the tracker and the day of the year (as counted from March Equinox).

Solar trackers may be configured to reposition solar energy collectors such that the energy produced is maximized due to a desirable placement in relation to the sun. Having the sunlight strike the solar panel at 90° (right-angle) throughout the day may ensure a maximized intensity of sunlight incident on the panel. The angle of sunlight reaching the solar panel in relation to the solar panel's orientation (e.g., azimuth and altitude facing) may be referred to herein as the “incidence angle” or the “angle of incidence.” A small to 0° incidence angle is often desirable for solar power generation. There may be rapid deterioration in solar power/intensity as the incidence angle increases (in some cases, 1% loss at 8°, 30% loss at 45°, greater than 75% loss at 75°) and therefore a deterioration in solar energy captured by the solar panel. To achieve a small to 0° incidence angle, it may be beneficial for the solar panel to keep track of the sun.

If the GPS coordinates of the solar panel and the date & time of measurement are known, it may be possible to determine the exact position of the sun in the sky using well-known solar calculations. If a solar tracker is self-aware of its relative position in terms of compass heading as well as tilt/roll angles, exact placement to increase or maximize solar energy collection may be possible. In a fixed-location solar installation, for example, GPS coordinates and a preset pattern may be indicated to a tracker in a set up step. However, means other than GPS may be used to track the sun in an energy-conscious manner.

A mechanically powered solar tracking system may be used to approximate positioning of a solar panel (collector) or a reflector based on the angular positioning and the elapsed time since the start of the tracking operation. The mechanically powered solar tracking system may be optimized for a portable design.

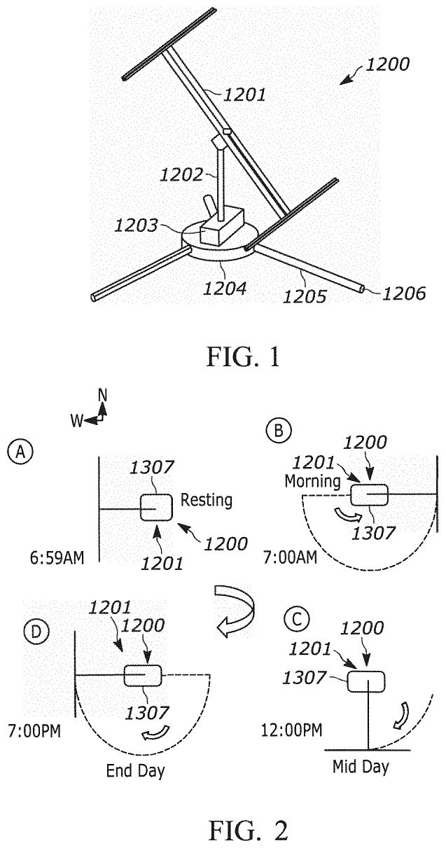

FIG. 1 provides a system level view and the various components make up the mechanically powered solar tracking system 1200. A carriage 1201 may be configured so that a solar panel (not shown) can be secured to it (e.g., mounted thereon). For example, the carriage 1201 may include brackets or mechanical fasteners (not shown) for mounting the solar panel thereon. A pivot shaft 1202, may be disposed between the carriage 1201 and a tracker 1203, mechanically connecting the carriage 1201 and the tracker 1203. The pivot shaft 1202 may be configured to pivot or rotate while being driven to track the Sun's azimuth position changes throughout the day. The tracker 1203 may house the mechanical charging mechanism (e.g., mechanical energy storage system, crank mechanism, spring-loaded mechanism, hydraulic mechanism, counter-weight mechanism, etc.) and tracker movement mechanism (e.g., pivot shaft 1202 rotation mechanism). A base 1204 may attach the carriage 1201, pivot shaft 1202, and tracker 1203 to legs 1205 for stability. Legs 1205 may be disposed at the base 1204 of the mechanically powered solar tracking system 1200 and be configured to provide ground stability for the mechanically powered solar tracking system 1200 as the potential energy stored via the tracker 1203 is released, the pivot shaft 1202 turns, and the carriage 1201 rotates. The legs 1205 may be fixed in size or telescoping. In the example shown, the legs 1205 are tripod legs but could be greater or fewer in quantity. Feet 1206 may be disposed on the tripod legs 1205 and may be configured to facilitate a staking of the mechanically powered solar tracking system 1200 to a ground surface to provide additional ground stability for the mechanically powered solar tracking system 1200 during operation.

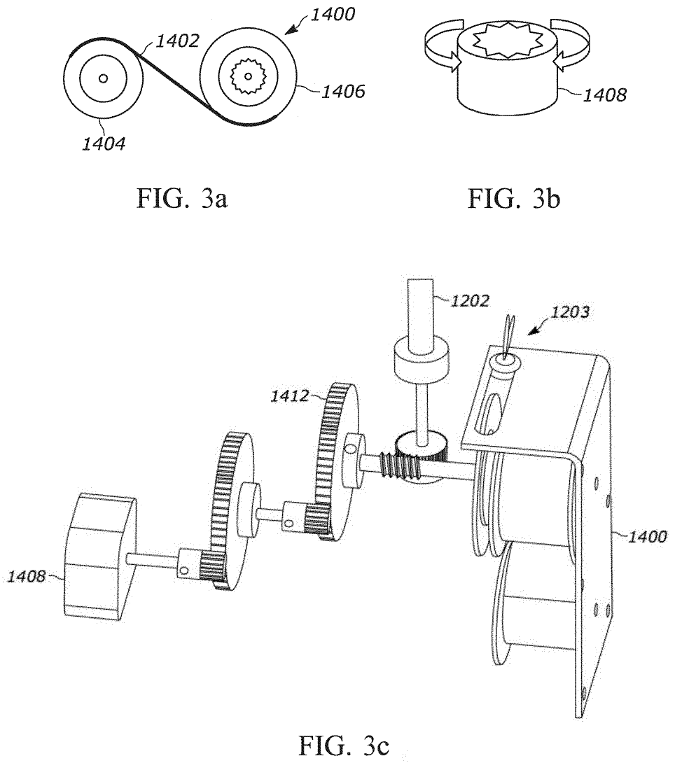

Operation of the mechanically powered solar tracking system 1200 may be dependent on a user (not shown) setting up the system 1200 such that the carriage 1201 or a portion or extension of the carriage 1201 of the solar panel/collector or reflector is positioned for east-to-west rotation. The user may mechanically charge the system 1200 (e.g., store mechanical energy within the system) by rotating the carriage 1201 from sunset to a current sun position or a sunrise position. In some embodiments, user provided mechanical energy is stored in a spring device (not shown) as the user spring-loads the mechanically powered solar tracking system 1200 by rotating the carriage to the spring-loaded position (e.g., by rotating the carriage 1201 from the sundown position to the current sun position or sunrise position). In other embodiments, a user may use a hand crank to energize a spring motor (FIG. 3c). User mechanical energy may be, for example, stored in a constant torque spring motor. The modulated release of this stored mechanical energy, provided at the start of the tracking operation, is used to rotate the carriage 1201. The sunrise position could be sunrise or pre-sunrise. Similarly, the sundown position could be sundown or post-sundown. After being mechanically charged, the mechanically powered solar tracking system 1200 may proceed to approximate a sun tracking rotation/movement by correlating the release of stored mechanical energy to a change in the sun's azimuth based on the phase of the day using a movement damping system (FIG. 3b).

FIG. 2 shows several top views of the mechanically powered solar tracking system 1200 at different moments of operation during a given day. In top view A, a user (not shown) has assembled the mechanically powered solar tracking system 1200, secured a solar panel 1307 in the carriage 1201, and aligned the mechanically powered solar tracking system 1200 for east to west rotation direction (e.g., the solar panel 1307 is facing westward). In top view B, a user has energized the system by moving the carriage 1201 to face the sun or to anticipate the sunrise, (e.g., by using a hand crank to energize a spring motor resident in the tracker), thereby mechanically charging the tracker 1203 of the mechanically powered solar tracking system 1200. The mechanical energy provided by the user during the charging motion is stored as potential energy in a mechanical energy storage system (FIGS. 3a-c, 4a-d) located in the tracker 1203. In top view C, the tracker 1203 modulates the release of stored mechanical energy and pivots the carriage 1201 and solar panel 1307 to approximate the sun's azimuth position as it changes. In top view D, the carriage 1201 and solar panel face westward, after tracking the azimuth position of the sun for an entire day.

FIG. 3a shows one possible embodiment including a constant torque spring motor 1400, a constant torque spring 1402 connected between an input drum 1404 and an output drum 1406. FIG. 3b shows a rotary counter torque damper 1408 configured to ensure a smooth, one-way rotation of the pivot shaft 1202. FIG. 3c provides a view of one possible arrangement for the tracker 1410, including the rotary force spring 1402 and rotary counter torque damper 1408 mechanically engaging a gearbox 1412 of the pivot shaft 1202 within the tracker 1203. In some embodiments, the gearbox 1412 may be replaced by a complex gearbox with multiple gears to provide solar tracking approximation based on latitude and time of the year at a given location.

The engagement of the gearbox 1412 of the pivot shaft 1202 may serve as the primary mechanical engagement between the carriage 1201 and the tracker 1203. The rotary counter torque damper 1408 may be configured to modulate the release of mechanical energy stored in constant torque spring 1402. The constant torque spring motor 1400 may be configured to store the mechanical energy input by the user while rotating that carriage 1201 from the sunset position toward the sunrise position or, by using a hand crank. A gear ratio between the gearbox 1412 and spring 1402 and a gear ratio between the gearbox 1412 and the rotary counter torque damper 1408, and a torque output on the pivot shaft 1202 may be chosen to cause the modulated movement of the carriage 1201 to properly approximate changes in the sun's azimuth position during a given day. In some embodiments, gearbox 1412 contains a plurality of gears engaged in complex arrangements.

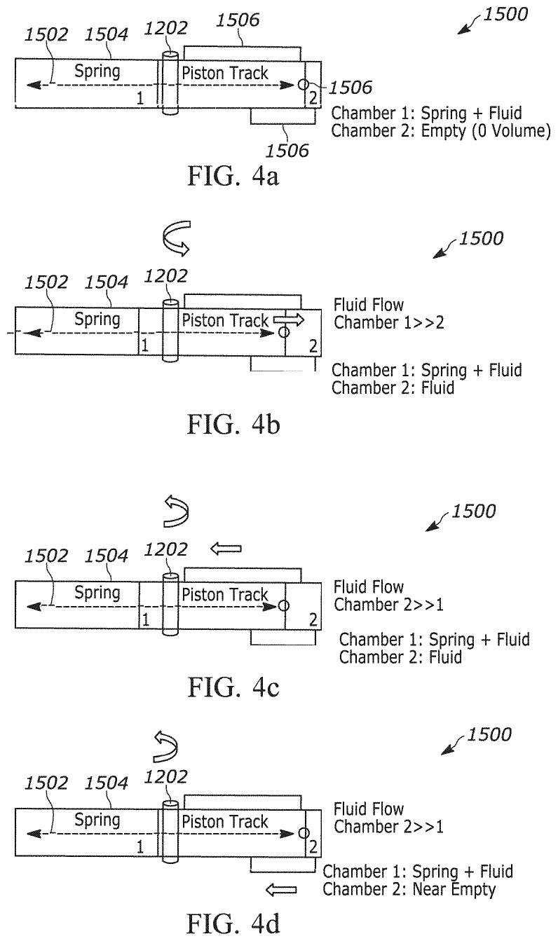

FIGS. 4a-d provide several views of a spring and hydraulics arrangement 1500 configured as the tracker 1203. FIG. 4a shows the arrangement 1500 in a neutral or balanced state before the starting operation of the arrangement 1500. FIG. 4b shows the arrangement 1500 being energized (e.g., by moving the carriage 1201 from a sunset position toward a sunrise position). In the embodiment shown, the user provided energy is stored as mechanical energy in the spring 1502. FIG. 4c shows the arrangement 1500 when the mechanically powered solar tracking system 1200 is tracking changes in the sun's azimuth in the morning through the rotation of gearbox 1412. In the embodiment shown, the release of energy stored in the spring 1502 is modulated by the restricted flow (e.g., morning valve or orifice) of fluid from chamber 2 to chamber 1. FIG. 4d shows the arrangement 1500 when the carriage 1201 is tracking changes in the sun's azimuth in the afternoon through the rotation of gearbox 1412.

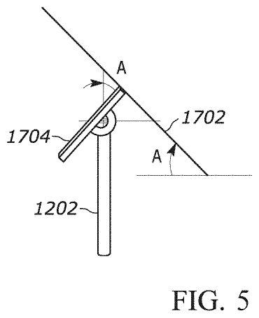

FIG. 5 shows a view of a mounting system 1700 provided for the user to set a desired altitude tilt for a solar panel 1702. A hinged arrangement 1704 between the pivot shaft 1202 and carriage 1201 may be configured to allow the user to set a desired altitude tilt between 90° and 0°.

A practical example of operating the mechanically powered solar tracking system 1200 is now described. A user may place the mechanically powered solar tracking system 1200 at a suitable location (e.g., sunshine all day). The user may then assemble the carriage 1201 and connect it to tracker 1203 using the pivot shaft 1202. The user may place the mechanically powered solar tracking system 1200 facing a sunset direction and align the sweep of the carriage 1201 in an east-west direction such that carriage 1201 generally follows the changing azimuth of the sun during the course of a day. The user may place the solar panel 1307 on the carriage 1201. The user may mechanically charge the mechanically powered solar tracking system 1200 by moving the carriage 1201 from a sunset position to a sunrise position or a current sun position. Alternatively, a user may use a hand crank to wind the constant torque spring motor 1400. The mechanically powered solar tracking system 1200 may then use the stored mechanical energy to track the sun's azimuth changes throughout the day and keep the solar panel at a desirable angle of incidence with respect to the sun.

Tracker 1203 modulates the release of mechanical energy stored in the constant torque spring motor 1400 through any appropriate means. In some embodiments, a spring damper is used. A spring damper may include a purely mechanical system where the release of stored mechanical energy in a spring is modulated by a combination of damper counter-force and gear ratio. In one embodiment, a 0.8475 N-m torque is exerted by the spring of the spring damper. Assuming an 85% efficiency, this torque translates to 5.763 N-m as exerted on the gearbox 1412. The rotary counter torque damper 1408 may apply a measured counter-torque to allow the gearbox 1412 to rotate at approximately 5 deg/20 min or 15 deg/hr thus approximating changes in the sun's azimuth under nominal conditions. In other embodiments, the aforementioned hydraulic spring system 1500, may be used to modulate the release of mechanical energy stored in compression spring 1502. The spring motor 1400 may have approximately the following dimensions: an input/storage drum diameter of 0.70 in, an output drum diameter of 1.22 in, a center distance between drums of 1.3 in, and a spring torque of 1.5 in-lbs. Additionally, the gearbox 1412 may have approximately the following dimensions: a gear reduction from storage drum to pivot shaft of 1:36, a torque reduction from storage drum to rotary damper of 150:1, and a rotary damper rated at 30 gf-cm at 20 rpm.

In some embodiments, to achieve a constant rate of rotation of 15° /hr for a single axis mechanically powered solar tracking system 1200 a constant force spring is paired with a damper and appropriate gear ratios between the spring (e.g., rotary force spring 1402, compression spring 1502), pivot shaft 1202, and rotary counter torque damper 1408 (e.g., a damper gear). The release of stored mechanical energy in a constant force spring (e.g., rotary force spring 1402) is modulated by a rotary counter torque damper 1408 providing a constant resistive force. To neutralize any influence from wind gusts up to 20 mph, torque in excess of 5 Nm may be applied to the pivot shaft 1202. A constant torque spring (e.g., rotary force spring 1402) with specification of 0.8475 Nm (e.g., 7.5 in lbs) torque may be configured as a “B Type Motor” with an input drum (e.g., storage drum and output drum 1406. A gear ratio of 8 between the pivot shaft 1202 and such a spring arrangement may provide an effective torque of 8×0.8475 Nm=5.763 Nm (e.g., at 85% efficiency). A rotary counter torque damper 1408 applying a constant rate of resistance (e.g., 0.48024 Nm) with a gear ratio of 12 between the gearbox 1412 and the rotary counter torque damper 1408 arrangement may allow the pivot shaft 1202 to rotate at a constant rate of 15°/hr.

In some embodiments, the mechanically powered solar tracking system 1200 may be implemented based on modulated release of stored mechanical energy in a compression spring 1502. To achieve a constant rate of rotation of 15°/hr for a single axis mechanically powered solar tracking system 1200, the compression spring 1502 may be paired with fluid hydraulics. In such an arrangement 1500, the release of stored mechanical energy in the compression spring 1502 is resisted by fluid pressure. This fluid pressure decreases over time as the fluid 1504 moves from one chamber to another through a valve/orifice. Naturally, the force applied by the compression spring 1502 decreases over time and is nonlinear. To compensate for this non-linear spring force, multiple valves/orifices 1506 with different flow-rates (e.g., a valve for use during mechanical charging, a valve for use during morning, an afternoon valve, etc.) may be used to modulate the rate of movement of the carriage 1201 in accordance with the rate of change in the azimuth of the sun during a given phase of the day (morning, afternoon). In this way, the movement of the pivot shaft 1202 may be modulated to achieve a near constant rate of rotation (15°/hr).

Although certain aspects have been described in detail with reference to certain preferred embodiments, variations and modifications exist within the scope and spirit of one or more independent aspects as described.

What is claimed is:

1. A mechanically powered solar tracking panel mount comprising:
a carriage;
a carriage mount connected to the carriage;
a pivot shaft including a pivot gear connected to the carriage;
a base including legs;
a tracker disposed on the base, the tracker including a mechanical energy storage system and a movement modulating system,
wherein the mechanical energy storage system is configured to store mechanical energy as the carriage is rotated from a first position to a second position, and
wherein the movement modulation system is configured to modulate a rotation of the carriage from the second position to the first position as the mechanical energy storage system exerts a rotational force on the carriage.

2. The mechanically powered solar tracking panel mount of claim 1, wherein the mechanical energy storage system is a rotational constant torque spring comprising an input drum and an output drum.

3. The mechanically powered solar tracking panel mount of claim 1, wherein the mechanical energy storage system is a compression spring.

4. The mechanically powered solar tracking panel mount of claim 1, wherein the movement modulation system is a counter torque rotary damper.

5. The mechanically powered solar tracking panel mount of claim 1, wherein the movement modulation system is a hydraulic piston.

6. The mechanically powered solar tracking panel mount of claim 1, wherein the base and legs form a tripod.

7. The system of claim 1 wherein the mechanical energy storage system is rotated from a first position to a second position using a hand crank.

8. The mechanically powered solar tracking panel mount of claim 1, further comprising a hinged arrangement 1704 between the pivot shaft 1202 and carriage 1201 may be configured to allow the user to set a desired altitude tilt between 90° and 0°.

9. A mechanically powered solar tracking system comprising:
a tracker including a mechanical energy storage system and a movement modulating system, the mechanical energy storage system and the movement modulating system being configured to mechanically engage a pivot shaft via a pivot gear,
wherein the mechanical energy storage system is configured to store mechanical energy as the pivot shaft is rotated from a first position to a second position, and
wherein the movement modulation system is configured to modulate a rotation of the pivot shaft from the second position to the first position as the mechanical energy storage system exerts a rotational force on the pivot shaft.

10. The mechanically powered solar tracking system of claim 9, wherein the mechanical energy storage system is a rotational force spring comprising an input drum and an output drum.

11. The mechanically powered solar tracking system of claim 9, wherein the mechanical energy storage system is a compression spring.

12. The mechanically powered solar tracking system of claim 9, wherein the movement modulation system is a damper gear.

13. The mechanically powered solar tracking system of claim 9, wherein the movement modulation system is a hydraulic piston.

14. The mechanically powered solar tracking system of claim 9, further comprising a base on which the tracker is disposed, and legs extending from the base.

15. The mechanically powered solar tracking system of claim 14, wherein the legs and base form a tripod.

16. The mechanically powered solar tracking system of claim 9, wherein the movement modulation system is configured to gate the movement of the pivot shaft to 15°/hr.

17. The mechanically powered solar tracking system of claim 9, wherein a complex adjustable gearbox arrangement provides an appropriate ratio to approximate solar tracking based on latitude and time of the year.
